(19) United States
(12) Patent Application Publication
(10) Pub. No.: US 2024/0149147 A1
(43) Pub. Date: May 9, 2024

(54) VIRTUAL BUTTON CHARGING

(71) Applicant: Bungie, Inc., Bellevue, WA (US)

(72) Inventor: Gregory PENG, Bellevue, WA (US)

(21) Appl. No.: 18/281,279

(22) PCT Filed: Mar. 9, 2022
(86) PCT No.: PCT/US2022/019648

§ 371 Date: Sep. 8, 2023

Related U.S. Application Data
(60) Provisional application No. 63/158,954, filed on Mar. 10, 2021.

(51) Int. Cl. A63F 13/2145; G06F 3/0488

(52) U.S. Cl. CPC A63F 13/2145; G06F 3/0488; A63F 2300/1037; A63F 2300/1075

(57) ABSTRACT

Described herein are techniques for implementing a virtualized physical controller. The techniques may comprise receiving, from a user via a touch-screen display, a first touch input associated with a charging operation, initiating, in response to receiving the first touch input, a first action associated with the charging operation, monitoring, prior to an execution of the first action, for a second touch input, the second touch input corresponding to an interrupt action, upon detecting the second touch input prior to the execution of the first action, executing the interrupt action, and upon failing to detect the second touch input by completion of the charging operation, executing the first action.

### BACKGROUND

Modern computer controller systems, such as those used by computer and video games, as well as by general-use operating systems, employ a variety of techniques to direct the movement of objects displayed on-screen. Known techniques include the use of an external control device such as a mouse, directional nub, touchpad, pen, game controller, or joystick to create either a directional vector or to designate a position for moving an on-screen object, such as a pointer or reticule, or to cause movement of a user's viewpoint. Some techniques can employ an additional layer of sophistication by measuring the speed of movement of the external device to enhance movement of the on-screen object by changing the behavior of the on-screen object in response to a parameter of the input (e.g., acceleration of a pointer based on the speed at which an external device is moved). Touch-enabled devices can also be configured to accept inputs in ways that simulate the behavior of external control devices. However, control schemes for touch-enabled devices tend to fall short of the tactile feel and responsiveness that have been achieved in physical controllers, and further development in this field is warranted. For example, some touch-enabled control schemes are presented in extant games, however, existing control schemes fail to take advantage of the flexibility conferred by virtualization.

### SUMMARY

Techniques are provided herein for implementing a virtual controller in which multiple actions may be executed via inputs received during a charge operation. Which action is executed may be determined based on one or more conditions that have been met, or have not been met, during the execution of the charge operation. In some cases, such a charge operation may further be configured and/or customized by a user.

In one embodiment, a method is disclosed as being performed by a user device, the method comprising receiving, from a user via a touch-screen display, a first touch input associated with a charging operation, initiating, in response to receiving the first touch input, a first action associated with the charging operation, monitoring, prior to an execution of the first action, for a second touch input, the second touch input corresponding to an interrupt action, upon detecting the second touch input prior to the execution of the first action, executing the interrupt action, and upon failing to detect the second touch input by completion of the charging operation, executing the first action.

An embodiment is directed to a computing system comprising a processor; and a memory including instructions that, when executed with the processor, cause the computing device to, at least receive, from a user, a first touch input associated with a charging operation, initiate, in response to receiving the first touch input, a first action associated with the charging operation, monitor, prior to an execution of the first action, for a second touch input, the second touch input corresponding to an interrupt action, upon detecting the second touch input prior to the execution of the first action, execute the interrupt action, and upon failing to detect the second touch input by completion of the charging operation, execute the first action.

An embodiment is directed to a non-transitory computer-readable media collectively storing computer-executable instructions that upon execution cause one or more computing devices to collectively perform acts comprising receiving, from a user via a touch-screen display, a first touch input associated with a charging operation, initiating, in response to receiving the first touch input, a first action associated with the charging operation, monitoring, prior to an execution of the first action, for a second touch input, the second touch input corresponding to an interrupt action, upon detecting the second touch input prior to the execution of the first action, executing the interrupt action, and upon failing to detect the second touch input by completion of the charging operation, executing the first action.

The foregoing, together with other features and embodiments will become more apparent upon referring to the following specification, claims, and accompanying drawings. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 is a simplified system diagram illustrating a service environment 100 in which a virtual controller can be used, in accordance with various embodiments of the present disclosure

FIG. 2 depicts an illustrative example of an environment in which a virtual controller is implemented in communication with a video game system in accordance with various embodiments

FIG. 3 is a block diagram showing various components of a computing system architecture that supports implementation of a virtualized physical controller in accordance with embodiments

FIG. 4 depicts a block diagram illustrating a process for performing a charge operation in accordance with embodiments

FIG. 5 depicts a graphical illustration of a process for executing a charge operation on a virtual controller in accordance with embodiments

FIG. 6 depicts a graphical illustration of a process for customizing and performing a charge operation on a virtual controller in accordance with embodiments

FIG. 7 depicts a flow diagram showing an example process 700 for initiating one or more actions based on input received from a user indicating a charge operation in accordance with embodiments; and

FIG. 8 depicts a flow diagram showing an example process flow 800 for performing a charge operation and performing either a first action or a second action in accordance with embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Embodiments herein are directed to techniques for causing a flatscreen virtual controller device to perform either a first or second action based on the duration of a charge (e.g., a time that a virtual button has been held) and the state of the player's in-game avatar or other suitable conditions. The controller state that can change includes audio and haptic feedback, appearance of the virtual button being held, new virtual buttons that are now available for the user to press, and non-interactive elements that may appear and provide status.

Embodiments of the disclosure provide for a number of advantages over conventional systems. Particularly, according to embodiments of the present disclosure, “charging” mechanics can be implemented in novel ways on a virtual controller that can improve over the implementations available for physical controllers.

For handheld flat screen devices that can be used as virtual controller (like mobile phones), screen real estate is at a premium. For games that are intended to be played holding the device in a horizontal (or “landscape”) fashion, there is limited space to provide input to the game with both hands and still have enough space to see actual in-game gameplay (if a mobile game) or to view the control scheme or ancillary information (if a console or PC game played with a virtual controller).

This space limitation means games need to be careful with the number and size of elements on a screen. When combined with physical contains of a human's hands (ex. size of the player's thumb, length of thumb nails, orientation and angle of thumb joint), there are hard constraints and trade-offs around wanting to provide more ways to give input (more buttons for more complex input actions), the size and locations of those buttons (impacting how easy they are for the user to physically touch), and the remaining “screen real estate” to see in-game action. For comparison, a typical modern console game traditionally uses 8 buttons to provide input, often with the expectation that players are using multiple buttons simultaneously (ex. using right thumb+right index simultaneously).

Lastly, the goal of input design is to enable input based on “muscle memory”. After a short training/instruction to controls, given a desire (“I want my in-game avatar to jump”), a user should no longer need to physically look at where the button is located on screen to know which button should hit. Their thumb should automatically and instinctively move to the correct location and touch the virtual button. Most mobile game approach these problems by either reducing the number of buttons (often by reducing the complexity of the game) or adding a large number of on-screen buttons that are transparent (to not block the in-game action).

For physical buttons providing input to a video game (e.g., a physical button on a physical controller), users can perform three actions: press the button, release the button, or hold the button pressed (often called “charging”). Of those three actions, “charging” enables the user to provide analog input (the duration of time they are holding the button down) in what normally is a binary input device (pressed or non-pressed). Most flat-screen games rely on techniques from games using physical controllers—change the state of the player's avatar (ex. crouching down in anticipation of jump if the player is holding the jump button) to show what “charging” the button is doing. Other games have a static UI element (like a meter) that fills up when the player charges a button. There are many good reasons games want to take advantage of the analog input of charging (allow input without adding additional buttons, it's intuitive to hold the button down, etc.), but a major problem is how to communicate status—how long has the button been held down, can the user hold it down forever, what options does the user have (let go vs press a different virtual button), etc. Some virtual controllers implemented on a touch-screen device use charging to diversify the actions that may be initiated while minimizing the number of buttons needed (resulting in reducing needed real estate). However, this often requires waiting for the user to finish charging and then determining what action was intended to be initiated after the charge has been completed. Accordingly, this may delay initiation of the action until the charge is complete, which can be problematic in games that require precise timing.

In contrast, embodiments of the virtual controller as described herein may initiate an action associated with a button, but the action may not be completed until the charge is complete. In such cases, the action itself is able to be interrupted and replaced with a different action throughout the charge process as intent is interpreted (e.g., via a different button push, release of button, etc.), which can make the charging mechanism more seamless while allowing for a greater diversity of actions that can be initiated.

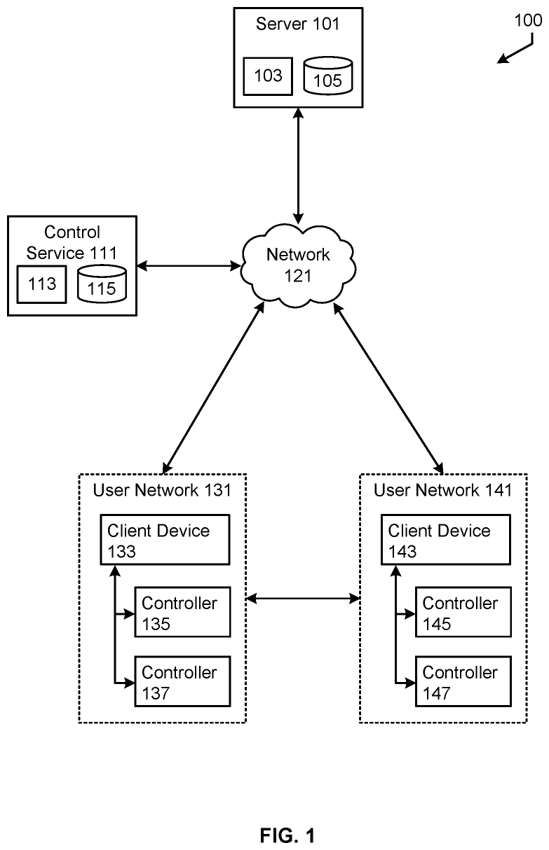

FIG. 1 is a simplified system diagram illustrating a service environment 100 in which a virtual controller can be used, in accordance with various embodiments of the present disclosure. The service environment 100 includes at least one server 101, which includes at least one processor 103 and non-transitory memory 105 storing as software instructions to facilitate operation of the service environment. The server 101 is connected via a network 121 (e.g., the Internet or a local network), with any suitable number of user-owned client devices 133, 143, which typically operate in conjunction with respective local user networks 131, 141 (e.g., consumer or commercial local area networks, WIFI networks, etc.)

The server 101 can also connect to any suitable number of control services 111, e.g., network-connected computing systems with their own processors 113 and memory 115 that monitor network to and from the server 101 and client devices 133, 143. In some embodiments, the server 101 can be one or more servers operating at commercial scale, e.g., a datacenter or server farm. Client devices 133, 143 can include, but are not limited to, consumer personal computers, video game consoles, thin-client devices operable to stream video content from the server 101 for presentation on a local screen, or mobile devices such as smartphones, tablets, or the like. Client devices 133, 143 can connect to any suitable number of controllers, e.g., controller 135, 137, 145, 147.

Each controller (e.g., controller 135) can be hardware devices (e.g., console-specific controllers, cross-compatible controllers, or virtual controllers) with connectivity hardware and protocols for communicating with their respective client device 133. According to some embodiments, controller 135 can be a virtualized controller operating on a thin-client device or touch-screen device, e.g., a controller simulated on a touchscreen smartphone, tablet, or console-like controller with a touch-enabled panel. According to some further embodiments, e.g., where the client device 133 is a thin-client device or mobile device, controller 135 can be a touchscreen with virtualized controls that is built-in to the client device. Alternatively, even where the client device 133 is a thin-client device, controller 135 can be a hardware controller configured to physically or wirelessly connect with the client device. According to some embodiments, the client device 133 and server 101 can operate on the same hardware, e.g., the client device running as a virtual instance on the server.

The methods described herein can be implemented on client devices in conjunction with a service environment such as service environment 100 described in FIG. 1. The methods can further work in the context of arbitrary placement of the virtual controller, which controls both avatar facing and movement, on-screen.

For clarity, a certain number of components are shown in FIG. 1. It is understood, however, that embodiments of the disclosure may include more than one of each component. In addition, some embodiments of the disclosure may include fewer than or greater than all of the components shown in FIG. 1. In addition, the components in FIG. 1 may communicate via any suitable communication medium (including the Internet), using any suitable communication protocol.

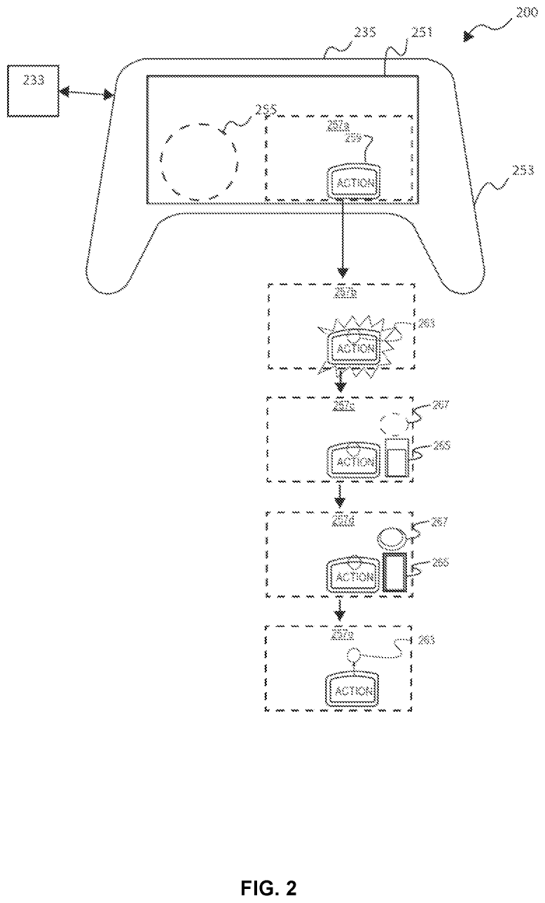

FIG. 2 depicts an illustrative example of an environment 200 in which a virtual controller 235 is implemented in communication with a video game system 233 in accordance with various embodiments. The virtual controller 235 includes a touchscreen 251, a frame 253, and virtualized controls, e.g., 255 and 257. For example, imagine. Using the example of a singular virtual button 259, we can start by tracking both the state of the button (touched or not touched) as well how long the button has been touched in milliseconds. When the button is initially touched 263 at 257b, we immediately change the visual appearance of the button icon, play haptic feedback, and play an audio event to let the user know their thumb has touched the button. Information about the button touch is used to control the avatar (ex. “action has been pressed”).

In some embodiments, a “progress amount” (e.g., 10%) may be maintained with respect to the “charge” operation. In these embodiments, the virtual controller may display a progress meter 265 filled to a value that represents the progress amount, as shown at 257c.

In some embodiments, additional input may be detected during the charge that causes the action associated with the charge operation to be interrupted. In some cases, additional input might be available to be provided only during a “charging” operation. If such additional input is to be made available, the virtual controller may dynamically display a virtual button 267, which may have one appearance (e.g., grayed-out or transparent) when not ready (257c) and a different appearance (e.g., three dimensional, brightened, more opaque) when ready (257d). If additional input is detected during the charging operation, the virtual controller may interrupt the current action associated with the charge operation and initiate a separate action associated with the additional input.

If the user takes their finger off the “charging” button, shown at 257e, the avatar is notified of the button release (ex. “throw the punch you have been winding up”). If the user holds the button for longer than the “progress amount” allows, the game system can respond in several ways depending on context. For example, in some cases the avatar will “release the charge” (ex. “throw the punch”) and the “progress meter” and virtual buttons will go away, providing strong visual indicia so that the user now understands they “held the charge too long.” Alternatively, the user can learn based on the “charge progress bar” filling to different amounts that they should time when they release the button (ex. “light or medium punch”), or they can trigger the dynamic button at different amounts (ex. “uppercut punch”). In some or all such cases, a visual change to the UI or an action by the avatar may be accompanied to aural and/or haptic feedback to reinforce the impression on the user.

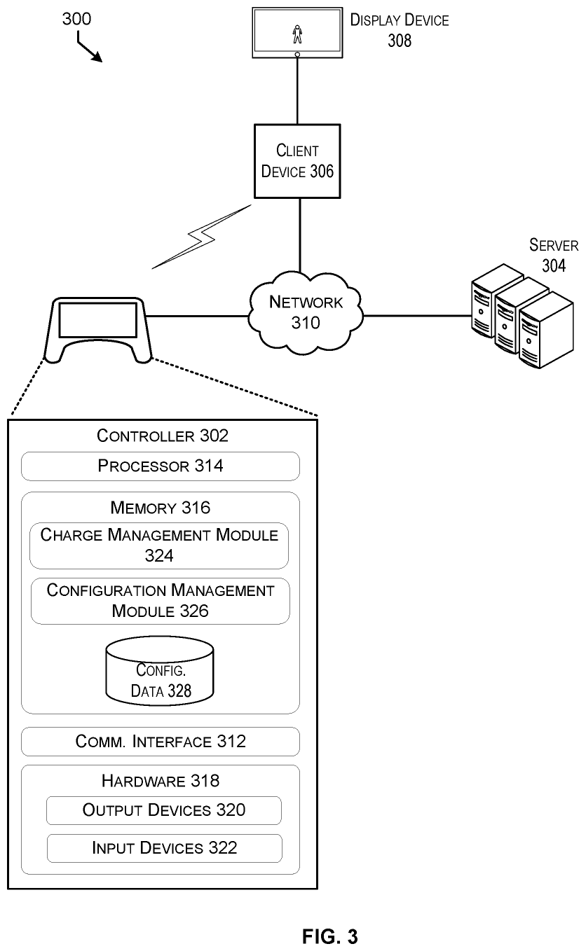

FIG. 3 is a block diagram showing various components of a computing system architecture that supports implementation of a virtualized physical controller in accordance with embodiments. The system architecture may include at least one controller 302. In some embodiments, the controller 302 may be in communication with one or more server 304, which may be an example of the server 101 as described with respect to FIG. 1. In some embodiments, the one or more server 101 may provide backend support for the controller 302. For example, at least a portion of the processing described as being performed by the controller 302 may instead be performed by the server 101 in some cases. In some embodiments, the controller 302 may be in communication with a client device 306. The client device 306 may be an example of client device 133 or 143 as described in relation to FIG. 1 above. In some embodiments, the client device 306 may be in further communication with a display device 308. Each of the components described herein may be in communication via a connection over a network 310.

The controller 302 may include any suitable computing device configured to perform at least a portion of the operations described herein and configured to enable a user to interact with a software application. In some embodiments, the controller may be a mobile device (e.g., a smartphone or tablet) having touchscreen capabilities. The controller 302 may include a communication interface 312, one or more processors 314, memory 316, and hardware 318. The communication interface 312 may include wireless and/or wired communication components that enable the controller 302 to transmit data to and receive data from other networked devices. The hardware 318 may include additional user interface, data communication, or data storage hardware. For example, the user interfaces may include at least one output device 320 (e.g., visual display, audio speakers, and/or haptic feedback device), and one or more data input devices 322. The data input devices 322 may include, but are not limited to, combinations of one or more of keypads, keyboards, mouse devices, touch-screen displays that accept gestures, microphones, voice or speech recognition devices, and any other suitable devices.

The memory 316 may be implemented using computer-readable media, such as computer storage media. Computer-readable media includes, at least, two types of computer-readable media, namely computer storage media and communications media. Computer storage media includes any suitable volatile and non-volatile, removable and non-removable media implemented in any method or technology for storage of information such as computer-readable instructions, data structures, program modules, or other data. Computer storage media includes, but is not limited to, RAM, DRAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms.

The one or more processors 314 and the memory 316 of the controller may implement functionality that includes one or more software modules and data stores. Such software modules may include routines, program instructions, objects, and/or data structures that are executed by the processors 314 to perform particular tasks or implement particular data types. More particularly, the memory 316 may include a module that is configured to determine a charge status for the virtual controller as well as determine one or more actions to be executed based on such a charge status (e.g., charge management module 324) as well as a module that is configured to maintain and implement configuration information for input mechanisms of a virtualized controller (e.g., configuration management module 326).

Additionally, the memory 316 may include various data stores. For example, the memory 316 may maintain data about virtualized controller configurations based on context (e.g., configuration data 328). In some embodiments, such configuration data may include an indication of one or more aspects of the input mechanisms that should be implemented based on state. For example, the configuration data may include an indication of a size, location, shape, appearance (e.g., color, shading, and/or text) of each input mechanism as related to individual states. In some cases, the configuration data may indicate which input mechanisms should or should not be presented during a particular state.

The charge management module 324 may be configured to, in conjunction with the processor 314, initiate one or more charge operations upon detecting that touch input has been received in relation to the charge operation. In some cases, the received touch input may be compared to information stored in association with one or more charge operations to determine whether a charge operation has been initiated.

The charge management module may be further configured to monitor for an interrupt input during the charge operation. In some cases, such an interrupt input may be any touch input that corresponds to a second action. For example, the user may hit a second button that is not involved in the charging operation to initiate a second action. In some cases, suitable an interrupt input may be a cessation of the charging operation. For example, the user may cease holding or tapping the charge button.

In some embodiments, upon detecting an interrupt input, the charge management module may be configured to identify and execute an appropriate interrupt action. In some cases, the interrupt action to be performed is determined based on whether one or more conditions have been met. For example, a first interrupt action may be performed if an amount of time that has elapsed since the initiation of the charge operation is less than a threshold amount of time whereas a second action may be performed if that amount of time is greater than the threshold amount of time. In embodiments, if no interrupt input is detected before the completion of the charge operation, the first action may be executed. In some embodiments, such as in the case that the charge operation corresponds to an action to be performed by a character (e.g., an avatar) in a video game, the charge operation may be accompanied by an animation associated with the action associated with the charge operation.

The configuration management module 326 may be configured to, in conjunction with the processor 314, generate and manage configuration information in relation to an arrangement of one or more input mechanisms within a user interface presented on the controller 302. In some embodiments, the configuration management module facilitates customization of input mechanism layout in accordance with some embodiments. It should be noted that such customization is described in related Patent Cooperation Treaty (PCT) Application Number US2022/019240, entitled “Virtualized Physical Controller,” by Gregory Peng, which is herein incorporated by reference in its entirety.

In some embodiments, configuration data may be customized by a user to indicate acceptable charging input by a virtual controller. For example, a user may provide an indication of a swipe path that include a series of locations on a touch-screen display. In this example, touch input received along the indicated swipe path may contribute toward a charging operation. In another example, a user may indicate a series of buttons (or other suitable input mechanisms). In this example, touch input received in relation to the series of buttons may contribute towards a charging operation. In embodiments, a user may be asked to indicate a preferred charging configuration in a manner similar to indicating a preferred input mechanism configuration as described.

The server 304 can include any computing device configured to perform at least a portion of the operations attributed to it. The server 304 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. The server 304 can include one or more virtual machines running virtual operating systems, or other computing architectures involving virtualization such as one or more flexible pools of logical storage devices that can be virtualized to maintain virtual storage devices for the computer. For example, the server 304 may include virtual computing devices in the form of virtual machines or software containers that are hosted in a cloud.

The client device 306 may include any suitable computing device configured to receive input from the controller 302 and perform an action based on that input. In some embodiments, the client device may be a gaming system, such as a gaming console that may receive input from a number of controllers, each of which may be used to control an avatar or character within a software application (e.g., a computer game).

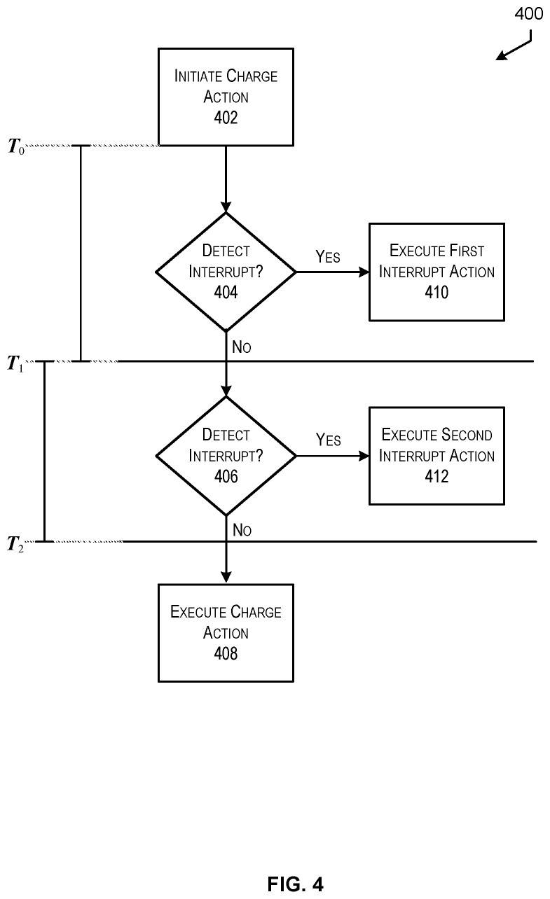

FIG. 4 depicts a block diagram illustrating a process for performing a charge operation in accordance with embodiments. The process 400 may be performed on a user device upon which a virtual physical controller is implemented, such as the controller 302 as described with respect to FIG. 3 above.

At 402, the process 400 may involve receiving, at time T₀, an indication that a charging operation has been initiated. In some embodiments, such an initiation may be detected upon receiving a touch input from a user that corresponds to a button or other input mechanism. In such cases, a determination may be made as to whether a charging operation has been initiated based on the type of touch input detected. For example, a determination may be made as to whether the button was pressed briefly or whether the button is being pressed continuously (e.g., tapped or held).

In some embodiments, a user may configure charge information for one or more actions based on his or her preferences. For example, the user may provide an indication of a series of touch inputs to be associated with a charge operation. Such a series of touch inputs may correspond to a combination of swipes, taps, and/or button presses.

During the process 400, an amount of charge may be monitored throughout the charging operation. In some cases, an amount of charge may be increased (e.g., built up) as one or more buttons (e.g., in a series of buttons) is pushed. In some cases, the amount of charge may be increased as time passes and a condition for the charge operation (e.g., holding a button) continues to be met. Once an appropriate amount of charge has been accumulated, or once a predetermined condition has been met (e.g., some time T2 has been reached), the initiated action may be performed at 408.

Throughout the charging operation, the virtual controller may monitor for one or more interrupt inputs. In some cases, such an interrupt input may be a touch input that is different from a touch input that is performed as part of the charging operation. In some embodiments, upon detecting an interrupt input, a determination may be made as to whether the interrupt input was detected before or after a predetermined condition occurs. An interrupt action (which may be different from the initiated action associated with the charge operation) may be performed upon detecting the interrupt input. Based on whether the interrupt input was detected before or after a predetermined condition occurred, a different interrupt action may be performed.

For example, if an interrupt input is detected at 404 after the charging operation has been initiated and before a condition has been met (e.g., before time T₁ has been reached), then a first interrupt action may be performed at 410. If, on the other hand, an interrupt input is detected at 406 after the condition has been met (e.g., after time T₁ has been reached), then a second interrupt action may be performed at 412.

It should be noted that while the FIG. 4 depicts a condition to be met as reaching a time T₁, such a condition might be any other suitable condition. For example, such a condition may include a touch input that corresponds to another button having been pushed. In another example, such a condition may include an indication that a user has ceased the charging operation (e.g., the user has released a charge button or ceased (for at least a predetermined amount of time) operations that increase the amount of charge.

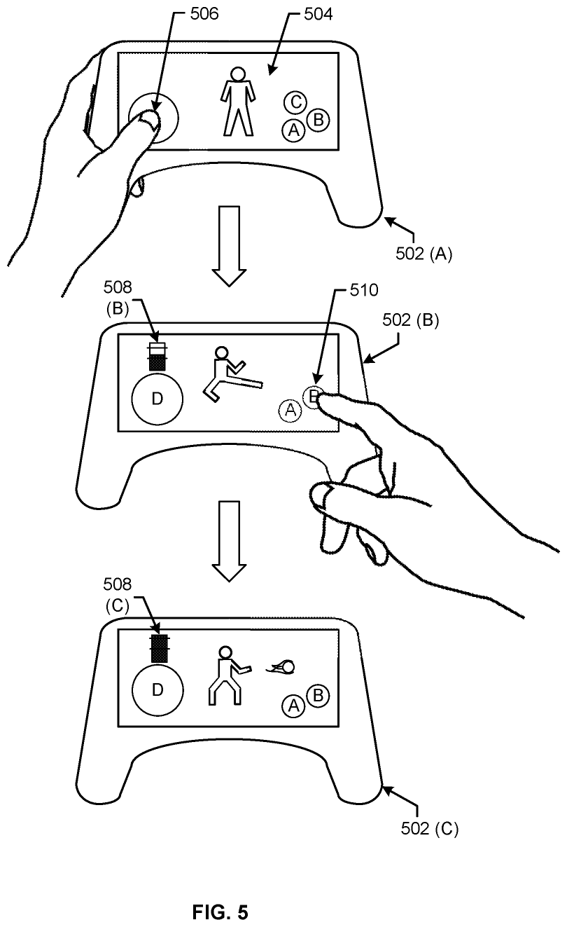

FIG. 5 depicts a graphical illustration of a process for executing a charge operation on a virtual controller in accordance with embodiments. The process 500 is depicted on a series of images of a user device 502 (A-C) on which a virtual controller may be implemented. As depicted, the virtual controller may be implemented via a graphical user interface (GUI) 504 that is presented on a touch-screen display. In some embodiments, the GUI may further depict a charge indicator 508 (e.g., 508 (A-C)). The charge indicator may be associated with a level of charge that represents a numeric value associated with the action to be performed.

In some embodiments, a user may provide touch input to a charge button as depicted at 506. Upon receiving the touch input, a charge operation may be initiated and the charge indicator may begin to be filled. In some cases, the charge indicator may be filled over time. In some cases, the charge indicator may be filled a predetermined amount each time that a touch input is received (e.g., each time that the charge button is pressed).

In some embodiments, an interrupt action may performed if an interrupt input is detected. For example, during the charge operation, a user may press a second button at 510 that is different from the charge button 506. In some embodiments, the interrupt action may be detected upon determining that a charge operation is no longer being performed. As a result of detecting the input related to the second button, the charge operation may be cancelled, the charge indicator may be emptied, and an interrupt action may be performed. In these embodiments, the interrupt action performed in response to receiving the interrupt input may be different from an action typically performed upon receiving touch input related to the button 510.

In some embodiments, a type of interrupt action to be performed may be determined on not only the type of interrupt action received, but whether one or more conditions have been met. For example, the type of interrupt action to be performed may depend at least in part on a degree to which the charge indicator has been filled. If no interrupt action is detected, and provided that the charging operation is completed, then an action associated with the charge operation may be performed.

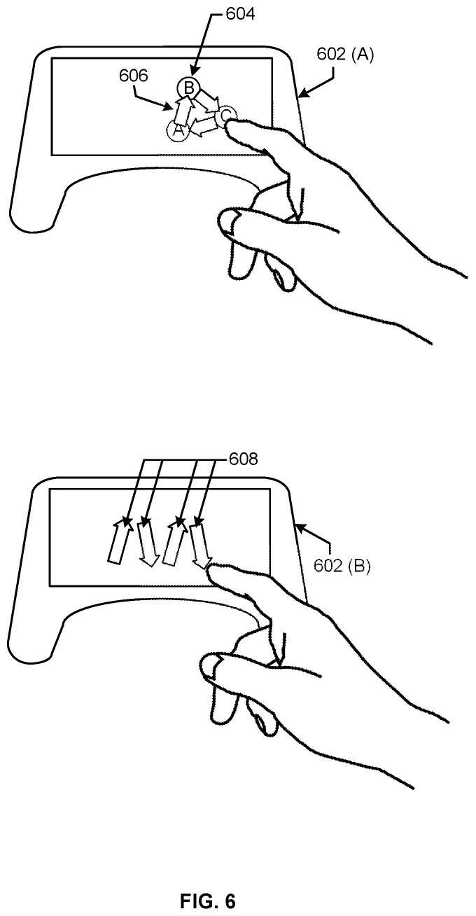

FIG. 6 depicts a graphical illustration of a process for customizing and performing a charge operation on a virtual controller in accordance with embodiments. The process 600 is depicted on a series of images of a user device 602 (A and B) on which a virtual controller may be implemented. As noted elsewhere, a charge operation may be configured to be performed in accordance with touch input as identified by a user.

In some cases, the user, during a configuration phase, may be provided an indication of a charge operation to be customized or configured. In these cases, the user may provide an indication of a series of touch input to be attributed to the indicated charge operation. Once the touch input has been provided, information about that touch input may be stored in relation to the charge operation. For example, one or more locations associated with the touch input may be stored. In some cases, an area surrounding the touch input may be stored, such that touch input received within that area may, upon being detected, be compared to the information stored about the charge operation to determine if such a charge operation was intended. Outside of the configuration phase, the touch input received by the user device that matches the indicated series of touch input to at least a desired degree, results in initiating, and/or continuing, the charging operation.

In some embodiments, the indicated touch input may be an identified series of buttons or other input mechanisms 604 as depicted at 602 (A). In some embodiments, execution of the charge operation by a user may involve the user performing a swipe or drag operation 606 by touching the touch-screen display and dragging the user's finger across multiple locations that include the series of buttons. In some cases, the drag operation may originate at the location of a first button in the series of buttons and may involve performing a drag across each of the series of buttons in order. In some embodiments, the charge operation may require that the user perform the drag operation across the series of buttons multiple times, which the charge being incremented each of those times.

In some embodiments, the indicated touch input may be an identified series of swipes 608 or other touch inputs that may be performed as depicted at 602 (B). Such a series of swipes may be an ordered series of swipes that must be completed in a particular order. In some embodiments, the series of swipes or other touch inputs corresponding to a charge operation may be a default series of swipes that is associated with the charge operation. In some embodiments, the series of swipes or other touch inputs corresponding to a charge operation may be a custom series of swipes indicated by a user (e.g., during a configuration phase). In some embodiments, the charge operation may be completed once the user has swiped each swipe in the series of swipes.

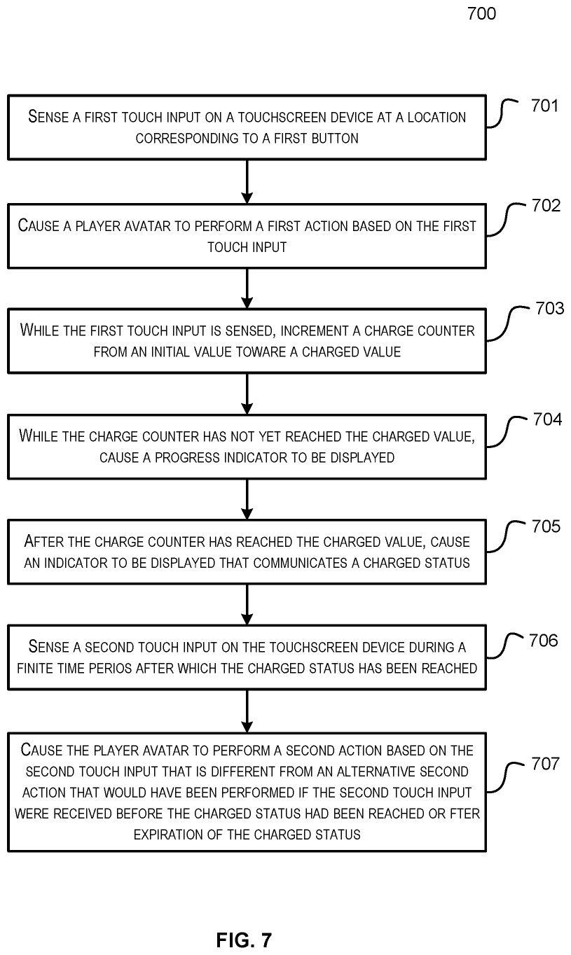

FIG. 7 depicts a flow diagram showing an example process 700 for initiating one or more actions based on input received from a user indicating a charge operation in accordance with embodiments. The process 700 can be performed on any suitable service environment, including but not limited to service environment 100 shown in FIG. 1. In accordance with various embodiments, process 700 includes sensing a first touch input on a touchscreen device at a location corresponding to a first button at 701. The system can then cause a player avatar to perform a first action based on the first touch input at 702, and while the first touch input is sensed, can begin incrementing a charge counter from an initial value toward a charged value at 703. During a finite first time period while the charge counter has not yet reached the charged value, a progress indicator can be displayed that communicates charge information based on the charge counter for presentation to the user, at 704. The progress indicator may take any suitable form such as a progress bar, a numerical indicator, a progression of color, etc.

During a finite second time period after the charge counter has reached the charged value, a status indicator to be displayed that communicates that the charge counter has reached the charged value at 705. In some embodiments, reaching the charged value can cause the system to dynamically display additional controls, e.g., another virtual button that can only be accessed in the charged state, a change in the effects of the button that has already been pressed to progress the charge, or a change in the effect of releasing the button that has been pressed to progress the charge. When a second touch input on the touchscreen device is received during the second time period at 706, e.g., a new button press, a release of the first touch input, or a button press of a dynamically generated button, the system causes the player avatar to perform a second action based on the second touch input that is different from an alternative second action that would have been performed if the second touch input were received before or after the second time period, at 707.

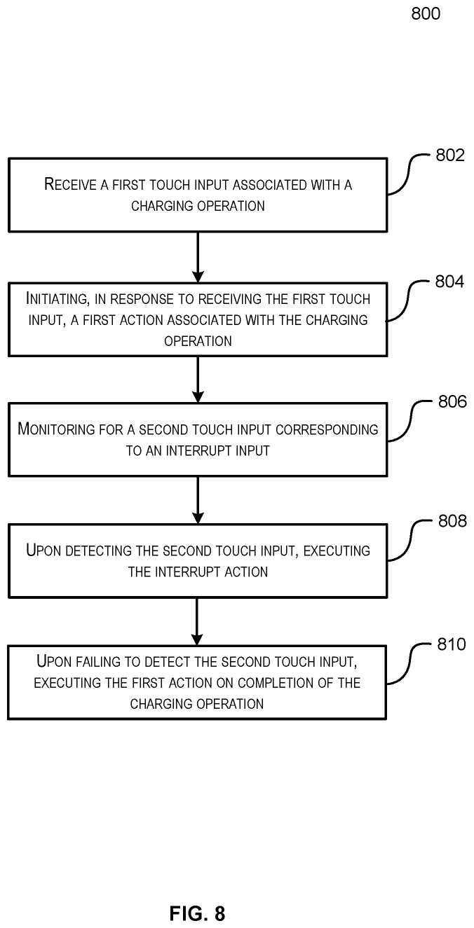

FIG. 8 depicts a flow diagram showing an example process flow 800 for performing a charge operation and performing either a first action or a second action in accordance with embodiments. The process 800 may be performed by a computing device that is configured to generate activation data based on user input. For example, the process 800 may be performed by a controller capable of facilitating interaction between the user and a software application, such as the controller 302 described with respect to FIG. 3 above. In some embodiments, such a software application is a video game played by the user.

At 802, the process 800 comprises receiving a first touch input associated with a charging operation. In some embodiments, the first touch input is compared to information stored in relation to the charging operation. In some cases, the information stored in relation to the charging operation may be a series of buttons displayed on the touch-screen display. Such a series of buttons may comprise an ordered series of buttons. In other words, the charging operation may require that the series of buttons be activated in a specific order. In some embodiments, the information stored in relation to the charging operation may be a series of swipe operations located on the touch-screen display. In some embodiments, the information stored in relation to the charging operation may be information customized by a user (e.g., during a configuration or setup phase).

At 804, the process 800 comprises initiating, in response to receiving the first touch input, a first action associated with the charging operation. In some embodiments, the first action comprises an action to be performed by a character portrayed in the video game. In some embodiments, the charging operation is accompanied by an animation associated with the first action.

At 806, the process 800 comprises monitoring for a second touch input that corresponds to an interrupt input. In some embodiments, each time that a second touch input is detected, that second touch input is compared to suitable interrupt inputs associated with interrupt actions.

At 808, upon detecting such a second touch input, the process 800 comprises executing an interrupt action. In some embodiments, the interrupt action to be executed is determined based at least in part on whether one or more conditions have been met during the charging action when the second touch input is detected. In some embodiments, whether the one or more conditions have been met comprise whether an amount of time from initiating the first action is greater than a time threshold value. In some embodiments, whether the one or more conditions have been met comprise ceasing the charging operation. At 810, upon failing to detect such a second touch input before completion of the charging operation, the process 800 comprises executing the first action.

The methods described herein are directed to virtual controllers, i.e., controllers that use a touchscreen or touchscreen-like functionality to provide for readily customized controller button layouts. According to some embodiments, the touchscreen is at least a portion of a physical, handheld controller that interfaces with a gaming device like a gaming console, personal computer, tablet, smartphone, thin client device (e.g., USB or HDMI device plugged in to a screen). According to some embodiments, the touchscreen is the predominant feature of the controller, which interfaces with a gaming device like a gaming console, personal computer, tablet, smartphone, thin client device (e.g., USB or HDMI device plugged in to a screen). According to some embodiments, the controller is made up of a mobile device or tablet in conjunction with enabling software that connects the mobile device or tablet to a gaming device like a gaming console, personal computer, thin client device (e.g., USB or HDMI device plugged in to a screen) or other suitable gaming device. According to some further embodiments, the touchscreen is a touch-enabled screen of a gaming device like a gaming console, personal computer, tablet, or smartphone.

The specification and drawings are to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as being essential to the practice of the invention.

Preferred embodiments of this disclosure are described herein, including the best mode known to the inventors for carrying out the invention. Variations of those preferred embodiments may become apparent to those of ordinary skill in the art upon reading the foregoing description. The inventors expect skilled artisans to employ such variations as appropriate and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In the following, further examples are described to facilitate understanding of aspects of the invention:

Example A. A method comprising:
receiving, from a user via a touch-screen display, a first touch input associated with a charging operation;
initiating, in response to receiving the first touch input, a first action associated with the charging operation;
monitoring, prior to an execution of the first action, for a second touch input, the second touch input corresponding to an interrupt action;
upon detecting the second touch input prior to the execution of the first action, executing the interrupt action; and
upon failing to detect the second touch input by completion of the charging operation, executing the first action.

Example B. The method of the preceding example, wherein the interrupt action to be executed is determined based at least in part on whether one or more conditions have been met during the charging operation when the second touch input is detected.

Example C. The method of any of the preceding examples, wherein whether the one or more conditions comprise a duration from initiating the first action having exceeded a time threshold value.

Example D. The method of any of the preceding examples, wherein whether the one or more conditions comprise a release, by the user, of the first touch input associated with the charging operation.

Example E. The method of any of the preceding examples, further comprising: monitoring a duration of the first touch input; and making accessible the second touch input when a duration of the first touch input exceeds a threshold.

Example F. The method of any of the preceding examples, further comprising generating a visible, tactile, or aural indicia for presentation to the user that the second touch input has been activated in response to the first touch input exceeding the threshold.

Example G. The method of any of the preceding examples, further comprising: while the first touch input is received, but before the duration has exceeded the threshold, generating a visible, tactile, or aural indicia for presentation to the user that communicates progress toward activating the second touch input.

Example H. The method of any of the preceding examples, further comprising: monitoring, prior to execution of the first action, for a third touch input, the third touch input corresponding to a modification of the charging operation; and upon detecting the third touch input prior to execution of the first action, modifying the charging operation.

Example I. The method of any of the preceding examples, wherein the modification of the charging operation comprises instructions customized by the user.

Example J. A user device comprising:
a processor; and
a memory including instructions that, when executed with the processor, cause the user device to, at least:
receive, from a user, a first touch input associated with a charging operation;
initiate, in response to receiving the first touch input, a first action associated with the charging operation;
monitor, prior to an execution of the first action, for a second touch input, the second touch input corresponding to an interrupt action;
upon detecting the second touch input prior to the execution of the first action, execute the interrupt action; and
upon failing to detect the second touch input by completion of the charging operation, execute the first action.

Example K. The user device of the preceding example, further comprising a touch-screen display, wherein the first touch input and the second touch input are received from the user via the touch-screen display.

Example L. The user device of any of the preceding examples, wherein the user device is one of a smartphone or tablet device.

Example M. The user device of any of the preceding examples, wherein the interrupt action to be executed is determined based at least in part on whether one or more conditions have been met during the charging operation when the second touch input is detected.

Example N. The user device of any of the preceding examples, wherein the instructions comprise a virtual controller capable of facilitating interaction between the user and a software application.

Example O. The user device of any of the preceding examples, wherein the software application comprises a video game played by the user.

Example P. The user device of any of the preceding examples, wherein the first action comprises an action to be performed by a character portrayed in the video game.

Example Q. The user device of any of the preceding examples, wherein the charging operation is accompanied by an animation associated with the first action.

Example R. A non-transitory computer-readable media collectively storing computer-executable instructions that upon execution cause one or more computing devices to collectively perform acts comprising:
receiving, from a user via a touch-screen display, a first touch input associated with a charging operation;
initiating, in response to receiving the first touch input, a first action associated with the charging operation;
monitoring, prior to an execution of the first action, for a second touch input, the second touch input corresponding to an interrupt action;
upon detecting the second touch input prior to the execution of the first action, executing the interrupt action; and
upon failing to detect the second touch input by completion of the charging operation, executing the first action.

Example S. The non-transitory computer-readable media of the preceding example, wherein the interrupt action to be executed is determined based at least in part on whether one or more conditions have been met during the charging operation when the second touch input is detected.

Example T. The non-transitory computer-readable media of any of the preceding examples, wherein whether the one or more conditions have been met comprise whether an amount of time from initiating the first action is greater than a time threshold value.

### CONCLUSION

Although the subject matter has been described in language specific to features and methodological acts, it is to be understood that the subject matter defined in the appended claims is not necessarily limited to the specific features or acts described herein. Rather, the specific features and acts are disclosed as exemplary forms of implementing the claims.

1. A method comprising:
receiving, from a user via a touch-screen display, a first touch input associated with a charging operation;
initiating, in response to receiving the first touch input, a first action associated with the charging operation;
monitoring, prior to an execution of the first action, for a second touch input, the second touch input corresponding to an interrupt action;
upon detecting the second touch input prior to the execution of the first action, executing the interrupt action; and
upon failing to detect the second touch input by completion of the charging operation, executing the first action.

2. The method of claim 1, wherein the interrupt action to be executed is determined based at least in part on whether one or more conditions have been met during the charging operation when the second touch input is detected.

3. The method of claim 2, wherein whether the one or more conditions comprise a duration from initiating the first action having exceeded a time threshold value.

4. The method of claim 2, wherein whether the one or more conditions comprise a release, by the user, of the first touch input associated with the charging operation.

5. The method of claim 1, further comprising:
monitoring a duration of the first touch input; and
making accessible the second touch input when a duration of the first touch input exceeds a threshold.

6. The method of claim 5, further comprising generating a visible, tactile, or aural indicia for presentation to the user that the second touch input has been activated in response to the first touch input exceeding the threshold.

7. The method of claim 5, further comprising: while the first touch input is received, but before the duration has exceeded the threshold, generating a visible, tactile, or aural indicia for presentation to the user that communicates progress toward activating the second touch input.

8. The method of claim 1, further comprising:
monitoring, prior to execution of the first action, for a third touch input, the third touch input corresponding to a modification of the charging operation; and
upon detecting the third touch input prior to execution of the first action, modifying the charging operation.

9. The method of claim 8, wherein the modification of the charging operation comprises instructions customized by the user.

10. A user device comprising:
a processor; and
a memory including instructions that, when executed with the processor, cause the user device to, at least:
receive, from a user, a first touch input associated with a charging operation;
initiate, in response to receiving the first touch input, a first action associated with the charging operation;
monitor, prior to an execution of the first action, for a second touch input, the second touch input corresponding to an interrupt action;
upon detecting the second touch input prior to the execution of the first action, execute the interrupt action; and
upon failing to detect the second touch input by completion of the charging operation, execute the first action.

11. The user device of claim 10, further comprising a touch-screen display, wherein the first touch input and the second touch input are received from the user via the touch-screen display.

12. The user device of claim 10, wherein the user device is one of a smartphone or tablet device.

13. The user device of claim 10, wherein the interrupt action to be executed is determined based at least in part on whether one or more conditions have been met during the charging operation when the second touch input is detected.

14. The user device of claim 10, wherein the instructions comprise a virtual controller capable of facilitating interaction between the user and a software application.

15. The user device of claim 14, wherein the software application comprises a video game played by the user.

16. The user device of claim 15, wherein the first action comprises an action to be performed by a character portrayed in the video game.

17. The user device of claim 16, wherein the charging operation is accompanied by an animation associated with the first action.

18. A non-transitory computer-readable media collectively storing computer-executable instructions that upon execution cause one or more computing devices to collectively perform acts comprising:
receiving, from a user via a touch-screen display, a first touch input associated with a charging operation;
initiating, in response to receiving the first touch input, a first action associated with the charging operation;
monitoring, prior to an execution of the first action, for a second touch input, the second touch input corresponding to an interrupt action;
upon detecting the second touch input prior to the execution of the first action, executing the interrupt action; and
upon failing to detect the second touch input by completion of the charging operation, executing the first action.

19. The non-transitory computer-readable media of claim 18, wherein the interrupt action to be executed is determined based at least in part on whether one or more conditions have been met during the charging operation when the second touch input is detected.

20. The non-transitory computer-readable media of claim 19, wherein whether the one or more conditions have been met comprise whether an amount of time from initiating the first action is greater than a time threshold value.
